(19) United States
(12) Patent Application Publication
(10) Pub. No.: US 2013/0122943 A1
(43) Pub. Date: May 16, 2013

(54) ESTABLISHING A COMMUNICATION EVENT

(71) Applicant: Audrius Masalskis, Palo Alto, CA (US)

(72) Inventor: Audrius Masalskis, Palo Alto, CA (US)

(21) Appl. No.: 13/341,589

(22) Filed: Dec. 30, 2011

(30) Foreign Application Priority Data
Nov. 10, 2011 (GB) 1119407.3

(51) Int. Cl. H04W 4/12

(52) U.S. Cl. 455/466

(57) ABSTRACT

A user terminal, method and computer program product for establishing a communication event, the user terminal includes a processor arranged to execute communication client code and image data decoding code; and means for capturing image data including (i) encoded contact information for a second user and (ii) encoded data defining a communication event related to the second user. The image data is supplied to the image data decoding code, the image data decoding code arranged to decode the image data and to supply decoded contact information decoded from the image data to the communication client code. Responsive to receiving the decoded contact information, the communication client code is configured to implement the communication event defined in the encoded data using the decoded contact information.

### RELATED APPLICATION

This application claims priority under 35 U.S.C. §119 or 365 to Great Britain Application No. GB 1119407.3, filed Nov. 10, 2011. The entire teachings of the above application are incorporated herein by reference.

### TECHNICAL FIELD

The present invention relates to establishing a communication event between first and second user terminals.

### BACKGROUND

On a mobile device, a list of contacts may be stored in memory which includes contact information such as the contacts name and telephone number(s). The list of contacts facilitates a quick and easy method of placing a voice or video call, or sending of an SMS (Short Message Service) or MMS (Multimedia Messaging Service) message to the contacts in the contact list. When a user of a mobile device wishes to send an SMS/MMS message or place a call to another person or company via the conventional fixed line or mobile cellular networks, for which the user does not have any contact information stored in the memory of their device, the user must first obtain this contact information. Once the user obtains the contact information i.e. a telephone number, the user must enter the telephone number in order to send the SMS/MMS message or place a call.

Some communication systems allow the user of a device, such as a personal computer, to conduct voice or video calls over a packet-based computer network such as the Internet. Such communication systems include voice or video over internet protocol (VoIP) systems. These systems are beneficial to the user as they are often of significantly lower cost than conventional fixed line or mobile cellular networks. This may particularly be the case for long-distance communication. To use a VoIP system, the user installs and executes client software on their device. The client software sets up the VoIP connections as well as providing other functions such as registration and authentication. In addition to voice communication, the client may also set up connections for other communication media such as instant messaging (“IM”), SMS messaging, file transfer and voicemail.

With increasing mobile bandwidths, there is increasing interest in providing packet-based voice and video calls via client applications running on mobile devices such as Internet-enabled mobile phones. These mobile devices comprise transceivers such as short-range RF transceivers operating on one or more unlicensed bands for accessing the Internet via wireless access points (e.g. of Wi-Fi access points of WLAN networks), and/or cellular transceivers operating on one or more licensed bands for accessing the Internet via a packet-based service of a cellular network such as GPRS (General Packet Radio Service) or HSPA (High Speed Packet Access).

When a user accesses the client application on their mobile device, a contact list configured by the user, may be downloaded to their device from a server in the communication system. This contact list facilitates a quick and easy method of placing a voice or video call, commencing a file transfer or initiating an IM chat with the contacts in the contacts list.

When a user of the mobile device wishes to perform one or more of these operations to contact an entity i.e. a person or company via the packet-based network, for which the user does not have any contact information stored in the contact list, the user must first obtain this information.

If the entity is connected to only the mobile cellular network or the fixed line network, the contact information of the entity may take the form of a telephone number; the user must enter the telephone number into the client application via a user interface in order to place a voice or video call to the entity via the packet-based network.

If the entity is connected to the packet based network and is executing the same client software as the user, the contact information of the entity may take the form of a username that is used to represent the entity to other users of the client software. The user must enter the username into the client application via a user interface in order to place a voice or video call to the entity via the packet-based network.

It will be appreciated that when a very large number of users are registered with the provider of the client software, this results in users having to use account names with a large number of characters (for example 10 or more). Therefore in order to contact the entity, the user may have to type a large number of characters into the client application via the user interface in order to place the voice or video call to the entity via the packet-based network.

When the user does not know the entity's username, the user may enter keywords (for example “John Smith”) into a contact search facility provided by the client application. It will be appreciated that when a very large number of users are registered with the provider of the client software, the contact search facility may return a plurality of username results for “John Smith”. Therefore the user would be uncertain as to the correct “John Smith” which the user should select to commence the voice or video call, file transfer or IM chat with.

### SUMMARY

In one aspect the invention provides a user terminal associated with a first user, the user terminal comprising: a processor arranged to execute communication client code and image data decoding code; and means for capturing image data including (i) encoded contact information for a second user and (ii) encoded data defining a communication event related to the second user, said image data being supplied to the image data decoding code, said image data decoding code arranged to decode said image data and to supply decoded contact information decoded from said image data to the communication client code, wherein responsive to receiving said decoded contact information the communication client code configured to implement the communication event defined in the encoded data using said decoded contact information.

Preferably, the image data is in the form of a barcode.

Preferably, the barcode is a linear barcode or a two dimensional barcode.

Preferably, the user terminal further comprises: means for accessing at least one of a cellular communication network and a circuit switched communication network. In this embodiment, the decoded contact information may include a telephone number of the second user and the communication event defined in the encoded data includes one of a SMS message, a MMS message, a voice call and a video call.

Preferably, the user terminal further comprises means for accessing a packet based network. In this embodiment, the decoded contact information may include a username of the second user, the username associated with the communication client code, and the communication event defined in the encoded data includes one of an instant messaging communication, a voice call or video call, via the packet based network. Responsive to receiving the decoded contact information the communication client code may be further configured to add the username of the second user to a contact list associated with the first user.

Preferably, the user terminal is configured to access at least one of the cellular communication network and the circuit switched communication network via the packet based network, wherein the decoded contact information includes a telephone number of the second user and the communication event defined in the encoded data includes one of a SMS message, a MMS message, a voice call and a video call.

Preferably, the user terminal further comprises means for receiving real time input from the first user wherein said real time input is conveyed to the second user via the communication event. Preferably, the communication event conveys input from the second user to the first user.

Preferably, the image data is generated by the second user.

Preferably, the user terminal is a mobile device.

Preferably, the mobile device is one of: an Internet-enabled mobile telephone; a handheld game console; a personal digital assistant (PDA); a tablet computer; a laptop computer.

Another aspect provides a method of establishing a communication event between first and second user terminals, the method comprising: executing communication client code and image data decoding code on a processor of the first user terminal; capturing image data at the first user terminal, the image data including (i) encoded contact information for a second user associated with the second user terminal and (ii) encoded data defining a communication event related to the second user; and supplying said image data to the image data decoding code; executing the image data decoding code to decode said image data; supplying decoded contact information decoded from said image data to the communication client code, wherein responsive to receiving said decoded contact information the communication client code implements the communication event defined in the encoded data using said decoded contact information.

Preferably, the method further comprises establishing the communication event over at least one of a cellular communication network and a circuit switched communication network.

Preferably, the method further comprises establishing the communication event over a packet based network.

Preferably, the method further comprises adding contact information of the second user to a contact list associated with the second user.

The invention also provides a computer program product comprising code embodied on a non-transient computer-readable medium and configured so as when executed on a processor receives decoded image data and automatically establishes a communication event defined in the image data to a user identified by contact information in the image data.

### BRIEF DESCRIPTION OF THE DRAWINGS

For a better understanding of the present invention and to show how it may be put into effect, reference is now made by way of example to the accompanying drawings in which:

FIG. 1 is a schematic representation of a communication system,

FIG. 2 is a schematic block diagram of a mobile terminal,

FIG. 3a is an example linear barcode,

FIG. 3b is an example 2D barcode,

FIG. 4 is an example advertisement incorporating a barcode,

FIG. 5 illustrates a method of establishing a communication event according to the invention.

### DETAILED DESCRIPTION

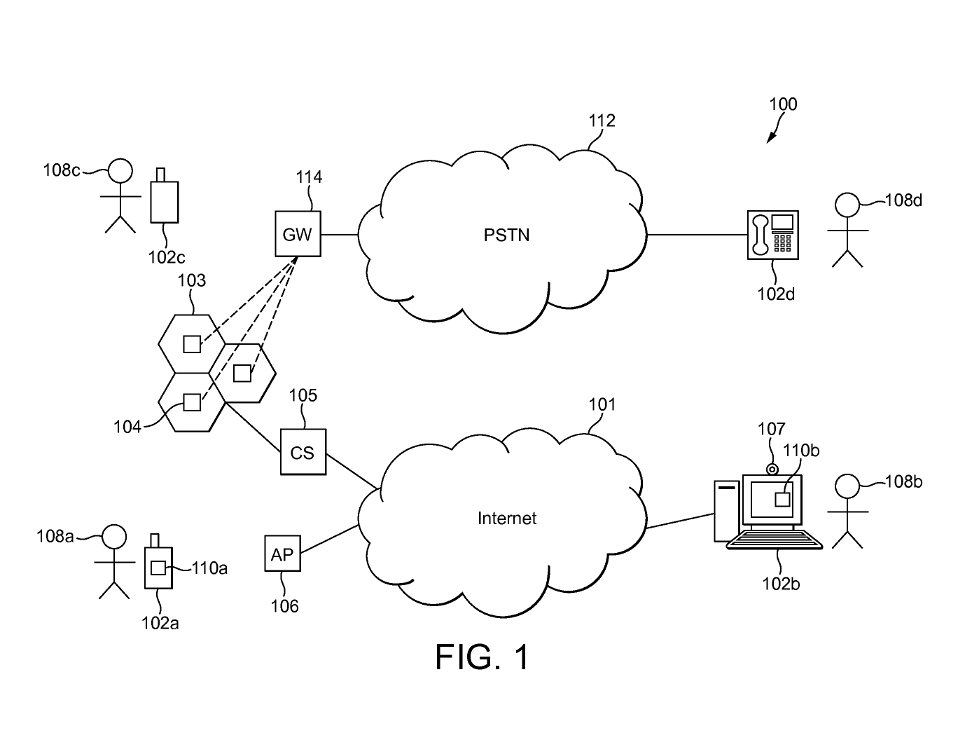

FIG. 1 is a schematic illustration of a communication system 100 comprising a packet-based network 101 such as the Internet, a mobile cellular network 103, and a circuit switched network112 such as the public switched telephone network (PSTN).

The mobile cellular network 103 comprises a plurality of base stations 104 (sometimes referred to as node Bs in 3GPP terminology). Each base station 104 is arranged to serve a corresponding cell of the cellular network 103. Each base station 104 is connected to the circuit switched network112 via a gateway 114. Further, the packet-switched network 101 comprises a plurality of wireless access points 106 such as Wi-Fi access points for accessing the Internet. These may be the access points of one or more wireless local area networks (WLANs).

A plurality of user terminals 102 are arranged to communicate over one or more of the networks 101,103,112. For merely illustration purposes only, FIG. 1 shows user terminal 102a as an Internet-enabled mobile device, user terminal 102b as a desktop or laptop PC, user terminal 102c as a cellular mobile phone 102c, and user terminal 102d as a landline telephone connected to the circuit switched network112.

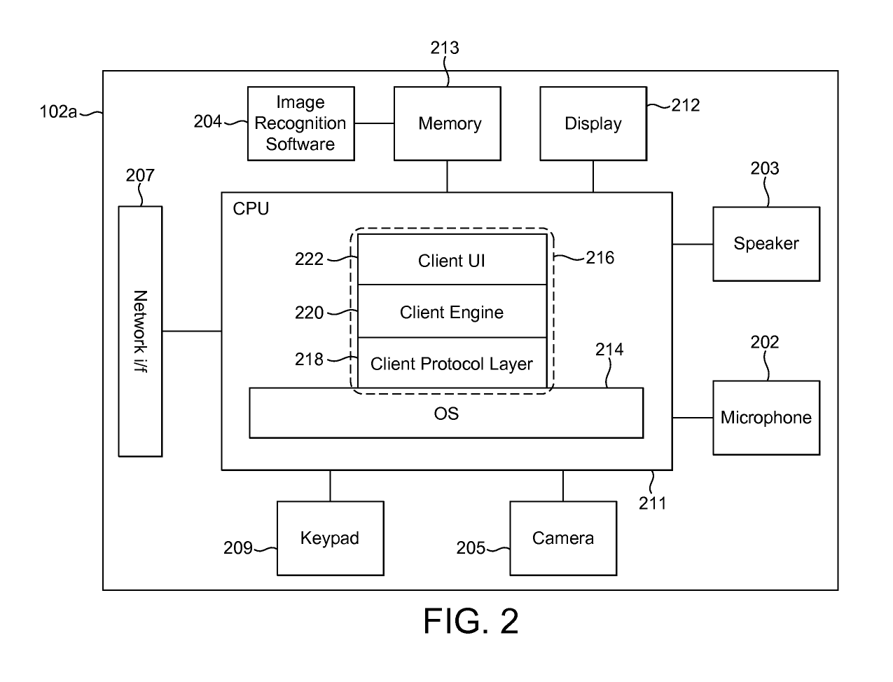

An example mobile device 102a is shown schematically in FIG. 2. The mobile device 102a may be one of an Internet-enabled mobile telephone; a handheld game console; a personal digital assistant (PDA); a tablet computer; or a laptop computer.

The mobile device 102a comprises a processing apparatus in the form of one or more processor units (CPUs) 211 coupled to a memory 213 storing a communication client application. The processor 211 is also coupled to: a microphone 202, a speaker 203, camera 205, one or more RF transceivers 207, a keypad 209, and a display 212.

The one or more transceivers 207 enable the mobile device 102a to access the one or more networks 101,103,112. For example, mobile device 102a may comprise a cellular wireless transceiver for accessing the mobile cellular network 103 via the base stations 104, and/or a wired or wireless modem for accessing the Internet 101. In the case of a wireless modem, this typically comprises a short-range wireless transceiver (e.g. Wi-Fi) for accessing the Internet 101 via the wireless access points 106.

Access to the Internet 101 may also be achieved by other means such as GPRS (General Packet Radio Service) or HSPA (High Speed Packet Access). At a higher level of the cellular hierarchy, the cellular network 103 comprises a plurality of cellular controller stations 105 each coupled to a plurality of the base stations 104. The controller stations 105 are coupled to a traditional circuit-switched portion of the mobile cellular network 103 but also to the Internet 101. The controller stations 105 are thus arranged to allow access to packet-based communications via the base stations 104, including access to the Internet 101. The controller stations 105 may be referred to for example as Base Station Controllers (BSCs) in GSM/EDGE terminology or Radio Network Controllers (RNCs) in USTM or HSPA terminology.

The memory 213 may comprise a non-volatile memory such as an electronic erasable and programmable memory (EEPROM, or “flash” memory) coupled to the processor 211. The memory stores communications code arranged to be executed on the processor, and configured so as when executed to engage in communications over one or more networks 101,103,112. The communications code preferably comprises a communication client application 110a provided by a software provider associated with the communication system. The communication client application 110a may be executed for performing communications such as voice or video calls with other user terminals 102 over the Internet 101, via a short-range wireless transceiver 207 and wireless access points 106, and/or via a cellular wireless transceiver 207, base stations 104 and controller stations 105 of the cellular network 103 as discussed above. However, one or more of the user terminals 102 involved could alternatively communicate via a wired modem, e.g. in the case of a call between a mobile terminal and a desktop PC.

As shown in FIG. 1 both user terminals 102a and 102b execute communication client software 110 in order for the user terminals 102a and 102b to transmit and receive data over the Internet 101.

FIG. 2 also illustrates an operating system (“OS”) 214 executed on the CPU 211. Running on top of the OS 214 is a software stack 216 for the client 110a. The software stack shows a client protocol layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the device 102a and handles the transmission and receipt of data via the network interface 207. The client protocol layer 218 of the client software communicates with the operating system 214 and manages the connections over the communication system. Processes requiring higher level processing are passed to the client engine layer 220. The client engine 220 also communicates with the client user interface layer 222. The client engine 220 may be arranged to control the client user interface layer 222 to present information to the user 108a via the user interface of the client and to receive information from the user 108a via the user interface.

Image recognition software 204 may be stored in memory 213 or in a separate memory not shown in FIG. 2. Therefore when the camera 205 captures image data, the CPU 211 may execute the image recognition software 204 to decode any information encoded in the image data. In embodiments of the present invention described more fully below, the image recognition software 204 supplies decoded information from a barcode to the client engine 220.

Barcodes are commonly known in the art to comprise encoded data such that they may be optically read, and the encoded information decoded in order to read information about an item that the barcode is attached to.

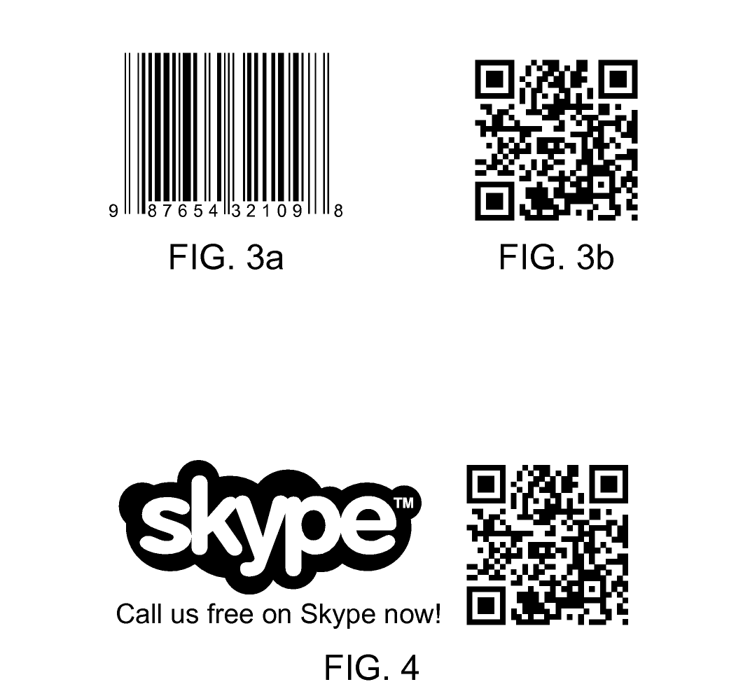

There are two types of barcodes, linear barcodes (an example of which is shown in FIG. 3a) and two dimensional (2D) barcodes, sometimes referred to as ‘matrix’ barcodes. One type of 2D barcode is the Quick Response (QR) barcode, an example of which is shown in FIG. 3b.

An increasing number of two dimensional barcodes are being used in advertising and other areas (for example, on public information boards) and ‘smartphones’ are being introduced on the market that can read the barcodes using a built-in camera. Currently, barcodes are used to transfer web uniform resource locators (URLs) to the mobile device that scans the barcode using a camera in-built into the mobile device.

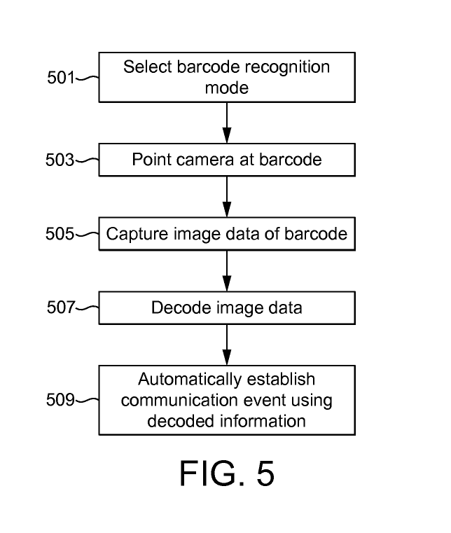

In embodiments of the present invention, decoded information from a barcode is used to implement a communication event without manual intervention by a user of the mobile device. A description of how embodiments of the invention may be implemented will now be provided with reference to FIGS. 4 and 5, by way of a non-limiting example.

In one example scenario a company may buy some advertising space in a public location. In order to provide additional functionality to the company's advert the company wishes to add an automated call option to facilitate product orders. In order to do so, a barcode is displayed in the advertising space, the barcode encoding a call identifier for establishing a call with the company, together with data defining that a call is to be set up. Such a barcode can be generated by a provider associated with the communication system that provides communication client application 110. Techniques used to generate a barcode are well known in the art and will not be discussed in detail.

To facilitate a third party (such as the company) in generating the barcode, a company representative is able to specify their contact information (e.g. username) and what type of action is performed at the device scanning the barcode responsive to a barcode scan. The generated barcode may then be incorporated into an advertisement. An example advertisement is illustrated in FIG. 4.

As an alternative to a username the encoded contact information can specify a telephone number for the company. Referring back to FIG. 1, if the company is represented by mobile device 102c the encoded contact information will include the telephone number of mobile device 102c. If the company is represented by user device 102d the encoded contact information will include the telephone number of user device 102d. If the company is represented by user device 102b the encoded contact information will include the username of user 108b executing client application 110b on user terminal 102b, wherein the username is used to identify the user 108b to other users of the client software 110.

The type of action includes encoded data defining a communication event related to the company. Referring back to FIG. 1, if the company is represented by mobile device 102c, the encoded data may define that the mobile device 102c is contacted by one of a SMS message, MMS message, voice call, or video call using the telephone number specified in the encoded contact information. Alternatively, if the company is represented by user device 102b, the encoded data may define an action that is triggered in the communication client application executed on the mobile device that has scanned the barcode (for example user device 102a). These actions may include opening an IM dialog box, or starting a voice or video call via the packet based network 101 between user device 102a and 102b. In addition the action may specify that the user 108b be added as a contact in the contact list associated with user 108a using the username specified in the encoded contact information (discussed above).

The example QR code incorporated into the advertisement shown in FIG. 4 specifies a username associated with the communication client 110b. In particular this code translates to ‘‘skype://sales_support?call’ and will trigger a call to user device 102b via the packet based network101 when transferred and decoded on a mobile device (which will be described later). In this example user 108b represents the sales support team of a company. Those skilled in the art will appreciate that the address format provided here is merely an example.

The method of establishing a communication event between mobile device 102a and user device 102b will now be discussed with reference to FIG. 5.

When an advertisement (such as the example shown in FIG. 4) is printed and visible in a public space, the user 108a of mobile device 102a may decide to establish a communication event with the sales support username without entering the sales support username or using the contact search facility provided by the client application to search for the sales support username.

When the communication client 110a is executed on user device 102a the client 110a presents an option to the user 108a to enter a barcode recognition mode. At step 501, the user 108a may enter this recognition mode by making an appropriate input selection for example pressing a button on mobile device 102a, touching the appropriate section of display 212 or making a voice command or the like.

At step 503, the user 108a points the camera 205 of the mobile device 102a at a barcode incorporated in the advertisement. The user 108a then makes an appropriate selection on mobile device 102a to capture image data of the barcode at step 505. It will be appreciated that the captured image data comprises encoded information including encoded contact information and encoded data defining a communication event related to the entity that generated the barcode.

As a result of the communication client 110a being in the barcode recognition mode, at step 507 the CPU 211 executes the image recognition software 204 to decode the image data and supplies decoded information to the communication client application 110a, the decoded information including decoded contact information and decoded data defining a communication event related to the entity that generated the barcode.

It will be appreciated that when the client 110a is not in the barcode recognition mode, and the user 108a uses camera 205 to capture image data the captured image data is stored in memory (whether internal or external) and no further action is taken.

At step 509, in response to receiving the decoded contact information, the communication client 110a establishes a communication event using the decoded information. That is the communication client establishes a communication event, for example opening an IM dialog box to chat with a person associated with the username sales_support, or starting a voice or video call via the packet based network 101 between user device 102a and a person associated with the username sales_support. In addition the username sales_support may be added as a contact in the contact list associated with user 108a.

In the example provided with reference to FIG. 5, the entity that generated the barcode specified that a username associated with client software 110 is contacted by the mobile device 102a that scanned the barcode. It will be appreciated that an entity generating the barcode may specify that a device 102c connected to cellular network 103 or a device 102d connected to circuit switched network 112 is contacted by the mobile device 102a that scanned the barcode (using methods as described above).

Embodiments of the present invention enable a user of a mobile device to contact another party, when contact details of the other party are not available to the user of the mobile device. Furthermore, the user of the mobile device is able to contact the other party immediately without having to type in a telephone number or enter the other party's username associated with the client software.

It will be appreciated that any type of barcode may be used in accordance with the present invention including all types of linear and 2D barcodes currently known in the art and any other barcode format that may be developed in the future. The barcodes may be applied to many different media including for example billboards, business cards, menus, flyers, company brochures, and displayed on websites.

It will be appreciated that the image recognition software 204 and the communication client software 110a may be code portions of a single executable computer program. Alternatively the image recognition software 204 and the communication client software 110a may be separately executable computer programs. The software may be stored on any form of non-transitory computer readable medium, such as random access memory (RAM), read only memory (ROM), compact disk read only memory (CD-ROM), flash memory, hard drive, and so forth.

While this invention has been particularly shown and described with reference to preferred embodiments, it will be understood to those skilled in the art that various changes in form and detail may be made without departing from the scope of the invention as defined by the appendant claims.

1. A user terminal associated with a first user, the user terminal comprising:
a processor arranged to execute communication client code and image data decoding code; and
an image capture device configured to capture image data including (i) encoded contact information for a second user and (ii) encoded data defining a communication event related to the second user, said image data being supplied to the image data decoding code, said image data decoding code arranged to decode said image data and to supply decoded contact information decoded from said image data to the communication client code, wherein responsive to receiving said decoded contact information the communication client code is configured to implement the communication event defined in the encoded data using said decoded contact information.

2. The user terminal according to claim 1, wherein the image data is in the form of a barcode.

3. The user terminal according to claim 2, wherein the barcode is a linear barcode or a two dimensional barcode.

4. The user terminal according to claim 1, wherein the user terminal further comprises:
means for accessing at least one of a cellular communication network and a circuit switched communication network.

5. The user terminal according to claim 4, wherein the decoded contact information includes a telephone number of the second user and the communication event defined in the encoded data includes one of a SMS message, a MMS message, a voice call and a video call.

6. The user terminal according to claim 1, wherein the user terminal further comprises means for accessing a packet based network.

7. The user terminal according to claim 6, wherein
the decoded contact information includes a username of the second user, the username associated with the communication client code, and
the communication event defined in the encoded data includes one of an instant messaging communication, a voice call or video call, via the packet based network.

8. The user terminal according to claim 7, wherein responsive to receiving said decoded contact information the communication client code further configured to add the username of the second user to a contact list associated with the first user.

9. The user terminal according to claim 6 wherein the user terminal is configured to access at least one of the cellular communication network and the circuit switched communication network via the packet based network, wherein the decoded contact information includes a telephone number of the second user and the communication event defined in the encoded data includes one of a SMS message, a MMS message, a voice call and a video call.

10. The user terminal according to claim 1, further comprising means for receiving real time input from the first user wherein said real time input is conveyed to the second user via the communication event.

11. The user terminal according to claim 10, wherein the communication event conveys input from the second user to the first user.

12. The user terminal according to claim 1, wherein the image data is generated by the second user.

13. The user terminal according to claim 1, wherein the user terminal is a mobile device.

14. The user terminal according to claim 13, wherein the mobile device is one of:
an Internet-enabled mobile telephone; a handheld game console; a personal digital assistant (PDA); a tablet computer; a laptop computer.

15. A method of establishing a communication event between first and second user terminals, the method comprising:
executing communication client code and image data decoding code on a processor of the first user terminal;
capturing image data at the first user terminal, the image data including (i) encoded contact information for a second user associated with the second user terminal and (ii) encoded data defining a communication event related to the second user;
supplying said image data to the image data decoding code;
executing the image data decoding code to decode said image data; and
supplying decoded contact information decoded from said image data to the communication client code, wherein responsive to receiving said decoded contact information the communication client code implements the communication event defined in the encoded data using said decoded contact information.

16. The method according to claim 15, further comprising establishing the communication event over at least one of a cellular communication network and a circuit switched communication network.

17. The method according to claim 15, further comprising establishing the communication event over a packet based network.

18. The method according to claim 15, further comprising adding contact information of the second user to a contact list associated with the second user

19. A computer program product comprising code embodied on a non-transient computer-readable medium and configured so as when executed on a processor receives decoded image data and automatically establishes a communication event defined in the image data to a user identified by contact information in the image data.

20. The user terminal according to claim 1, wherein the image capture device is a camera.
